(19) United States
(12) Patent Application Publication
(10) Pub. No.: US 2002/0126838 A1
(43) Pub. Date: Sep. 12, 2002

(54) Modular exponentiation calculation apparatus and modular exponentiation calculation method

(76) Inventors: Atsushi Shimbo, Fuchu-shi (JP); Hanae Ikeda, Yokohama-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/051,276

(22) Filed: Jan. 22, 2002

(30) Foreign Application Priority Data
Jan. 22, 2001 (JP) 2001-013565

(51) Int. Cl. H04K 1/00

(52) U.S. Cl. 380/28

(57) ABSTRACT

A modular exponentiation calculation apparatus obtains a first RNS representation of a value Cp^{dp}×B mod p based on an RNS representation of a remainder value Cp=C mod p and a remainder value dp=d mod (p−1), obtains a second RNS representation of a value Cq^{dq}×B mod q based on an RNS representation of a remainder value Cq=C mod q and a remainder value dq=d mod (p−1), obtains a third RNS representation of an integer m′ congruent with C^{d} mod (p×q) based on both the first and second RNS representations, and obtains m=C^{d} mod (p×q) based on a value of the integer m′ obtained by converting the third RNS representation into a binary representation.

### CROSS-REFERENCE TO RELATED APPLICATIONS

This application is based upon and claims the benefit of priority from the prior Japanese Patent Application No. 2001-013565, filed Jan. 22, 2001, the entire contents of which are incorporated herein by reference.

### BACKGROUND OF THE INVENTION

1. Field of the Invention

The present invention relates to a modular exponentiation calculation apparatus and modular exponentiation calculation method for obtaining m=C^{d} mod (p×q) with respect to object data C and independent parameters p, q, d.

2. Description of the Related Art

There has been proposed an algorithm and a hardware for uniting and realizing modular multiplication as a basic element for realizing algorithm (modular exponentiation calculation) of a public key cryptography with Montgomery multiplication based on a residue number system (RNS) representation which enables a parallel processing of integer operation (addition/subtraction/multiplication). This will be referred to as RNS Montgomery multiplication.

The residue number system representation (RNS representation) will be described. For many types of public key cryptography such as an RSA cryptography, a multiple-precision integer is utilized to perform conversion, and a radix representation in which a radix is 2, so-called binary representation, is usually utilized in the representation of the multiple-precision integer. For another representation, a method of preparing a pluraity of moduli a₁, a₂, . . . , aₙ, and representing an integer x by a set of remainder values x₁, x₂, . . . , xₙ by these moduli as in the following equations is utilized.

x₁=x mod a₁

x₂=x mod a₂

. . .

xₙ=x mod aₙ

This representation method is called an RNS representation.

A group of moduli for use in the RNS representation will hereinafter be referred to as a base. Moreover, an element number n of the base will be referred to as a base size. The base “a” having a base size of n is represented as follows.

a={a₁, a₂, . . . , aₙ}

In the RNS representation, positive integers prime to one another are usually used, and Chinese remainder theorem guarantees that the positive integer less than a product of elements of the base can uniformly be represented by the RNS representation. That is, when the base is a={a₁, a₂, . . . , aₙ}, and the product of elements of the base “a” is A=a₁×a₂×. . . ×aₙ, the positive integer less than A can be represented by the RNS representation using the base “a”.

In the following, n integers x subjected to the RNS representation using the base “a” are represented by <x>ₐ (sometimes represented by <x> in which the base is omitted). That is, the following results.

<x>ₐ=(xₐ₁, xₐ₂, . . . , xₐₙ)=(x mod a₁, x mod a₂, . . . , x mod aₙ)

Additionally, when two types of bases are used in the following operation, with respect to bases a={a₁, a₂, . . . , aₙ₁} and b={b₁, b₂, . . . , bₙ₂}, a∪b denotes a combination of {a₁, a₂, . . . , aₙ₁} and {b₁, b₂, . . . , bₙ₂}, and <x>_{a∪b} denotes the RNS representation of x by the base a∪b (i.e., <x>_{a∪b} denotes a combination of <x>ₐ=(x mod a₁, x mod a₂, . . . , x mod aₙ₁) and <x>_{b}=(x mod b₁, x mod b₂, . . . , x mod bₙ₂). Moreover, in the following description, for the sake of convenience two types of bases will be described as n1=n2=n. Additionally, n1, n2 do not have to be equal to n.

The RNS representation is advantageous in that addition, subtraction, and multiplication can easily be carried out using the product “A” of all the elements of the base. That is, desired results are obtained as results of independent addition, subtraction, and multiplication of the respective elements by the respective moduli as follows.

<x>ₐ+<y>ₐ=(xₐ₁+yₐ₁, xₐ₂+yₐ₂, . . . , xₐₙ+yₐₙ)

<x>ₐ−<y>ₐ=(xₐ₁−yₐ₁, xₐ₂−yₐ₂, . . . , xₐₙ−yₐₙ)

<x>ₐ×<y>ₐ=(xₐ₁×yₐ₁, xₐ₂×yₐ₂, . . . , xₐₙ×yₐₙ)

Additionally, the above operations will be referred to as RNS addition, RNS subtraction, and RNS multiplication, respectively. A left side is mod A, and respective terms of a right side are mod a₁, mod a₂, . . . , mod aₙ.

Therefore, n operations can be processed in parallel. When n operation units are prepared, all the operations are processed in parallel, and a fast processing is realized. Even when the number of prepared operation units is less than n, an operation speed can be enhanced in proportional to the number of units of 1 to n.

RNS Montgomery multiplication and RNS Montgomery exponentiation will next be described.

The RNS Montgomery multiplication is a method of applying a method called Montgomery multiplication to the operation in the RNS representation with respect to multiplication <x>_{a∪b}×<y>_{a∪b} with a remainder in mudulus N, and is generally carried out in the following procedure.

The RNS Montgomery multiplication is represented by MM(<x>_{a∪b}, <y>_{a∪b}, N, a∪b).

Here, inputs are <x>_{a∪b}, <y>_{a∪b}, N. Additionally, x and y are both less than 2N.

Bases are a, b. Additionally, x, y, N are all less than A, and less than B.

An output is <w>_{a∪b}. Additionally, w=(x×y×B⁻¹ mod N)+N. Moreover, there is not +N in some case.

<Processing Content>

step-M-0: <−N⁻¹>_{b} is calculated.

step-M-1: <s>ₐ=<x>ₐ×<y>ₐ is calculated.

step-M-2: <s>_{b}<x>_{b}×<y>_{b} is calculated.

step-M-3: <t>_{b}=<s>_{b}×<−N⁻¹>_{b} is calculated.

step-M-4: <t>_{b} is base-converted to <t>ₐ.

step-M-5: <u>ₐ=<t>ₐ×<N>ₐ is calculated.

step-M-6: <v>ₐ<s>ₐ+<u>ₐ is calculated.

step-M-7: <w>ₐ=<v>ₐ×<B⁻¹>ₐ is calculated.

step-M-8: <w>ₐ is base-converted to <w>_{b}.

Additionally, in the above procedure, the base conversion of the step-M-4 or step-M-8 is a processing for obtaining the RNS representation by another base (e.g., RNS representation <t>ₐ by a base “a”) of a certain integer corresponding to the RNS representation by a certain base (e.g., integer t corresponding to RNS representation <t>_{b} by the base “b”).

An RNS Montgomery multiplier can also realize a fast processing by increasing the operation unit for performing the processing in parallel.

Moreover, there has been proposed a method of repeatedly performing the RNS Montgomery multiplication (repeatedly utilizing the RNS Montgomery multiplier) to perform an exponentiation calculation; and constituting a cryptography processing of an RSA cryptography. This exponentiation calculation method will be referred to as the RNS Montgomery exponentiation. The RNS Montgomery exponentiation is generally carried out in the following procedure.

The RNS Montgomery exponentiation is represented by MEXP (<x>_{a∪b}, d, N, a∪b).

Here, an input is <x>_{a∪b}, exponent (binary representation) is d=(dₖ, dₖ₋₁, . . . , d₁), and modulus is N. Additionally x<2N.

Bases are a, b. Additionally, x, N are both less than A, and less than B.

An output is <y>_{a∪b}. Additionally, y=x^{d}×B^{-(d-1)} mod N.

<Processing Content>

step-E-1: i=k is set. <y>_{a∪b}=<B>_{a∪b} is set.

step-E-2: <y>_{a∪b}=MM (<y>_{a∪b}, <y>_{a∪b}, N, a∪b) is calculated.

step-E-3: If dᵢ=1, <y>_{a∪b}=MM (<y>_{a∪b}, <x>_{a∪b}, N, a∪b) is calculated. If dᵢ≠1, nothing is carried out (nop).

step-E-4: i=i−1 is set.

step-E-5: If i=0, the procedure ends. If i≠0, the procedure returns to step-E-2.

Additionally, in the above procedure, MM( ) in the step-E-2 and step-E-3 denotes the aforementioned RNS Montgomery multiplication.

A CRT modular exponentiation calculation will next be described.

For the RSA cryptography, with respect to a public key (N, e), and secret key (d, p, q), a plaintext m is enciphered into a ciphertext C with C=m^{e} mod N, and the ciphertext C is deciphered into the plaintext m with m=C^{d} mod N. Here, an exponentiation calculation method which utilizes secret prime factors p, q of a modulus N as the public key to efficiently execute decipherment, that is, which utilizes a Chinese remainder theorem (CRT) is known. This exponentiation calculation method will be referred to as the CRT modular exponentiation calculation.

<CRT Modular Exponentiation Calculation Procedure>

step-C-1: dₚ=d mod (p−1)

d_{q}=d mod (q−1)

step-C-2: Cₚ=C mod p

C_{q}=C mod q

step-C-3: mₚ=Cₚ^{dp} mod p

m_{q}=C_{q}^{dq} mod q

step-C-4: m=mₚ×(q⁻¹ mod p)×q+m_{q×(p}⁻¹ mod q)×p (mod N)

Additionally, in the above procedure, since parameters dₚ, d_{q}, (q⁻¹ mod p), (p⁻¹ mod q) depend only on the secret key, the parameters are generally calculated beforehand and stored as a part of the secret key.

Noting that a dominant portion of a calculation amount of the CRT modular exponentiation calculation corresponds to two modular exponentiation calculations of the step-C-3, and the modular exponentiation calculation is proportional to a cube of a size of the modulus, it is seen that the calculation amount of the modular exponentiation calculation in the binary representation and CRT modular exponentiation calculation is about ¼ (=2/8). Additionally, when the modular exponentiation calculation of the step-C-3 is simultaneously executed in two calculation circuits, a calculation time can be expected to be reduced to about ⅛.

However, a concrete method for realizing the CRT modular exponentiation calculation of the step-C-1 to step-C-4 by the RNS Montgomery multiplication has not been realized, and it has been difficult to raise a speed of the modular exponentiation calculation of a large integer such as RSA decipherment (secret conversion).

### BRIEF SUMMARY OF THE INVENTION

According to the present invention, there is provided a modular exponentiation calculation apparatus or modular exponentiation calculation method in which a modular exponentiation calculation is efficiently executed.

According to an embodiment of the present invention, a modular exponentiation calculation apparatus which utilizes a residue number system representation by a first base and a second base including sets of a plurality of integers with respect to object data C and parameters p, q, d (all integers included in both the bases are mutually primary, a product “A” of all the integers of the first base is A>p, A>q, a product “B” of all the integers of the second base is B>p, B>q, and A×B>C) to obtain a calculation result m=C^{d} mod (p×q), the apparatus comprising:

a first processing unit configured to obtain a residue number system representation of a value Cp^{dp}×B mod p or a value with p added thereto based on a residue number system representation of a remainder value Cp=C mod p by p of the data C and a remainder value dp=d mod (p−1) by (p−1) of the parameter d;

a second processing unit configured to obtain a residue number system representation of a value Cq^{dq}×B mod q or a value with q added thereto based on a residue number system representation of a remainder value Cq=C mod q by q of the data C and a remainder value dq=d mod (p−1) by (q−1) of the parameter d;

a third processing unit configured to obtain a residue number system representation of an integer m′ congruent with C^{d} mod (p×q) based on both the residue number system representations obtained by the first and second processing units; and

a fourth processing unit configured to obtain the calculation result m based on a value of the integer m′ obtained by converting the residue number system representation obtained by the third processing unit into a binary representation.

### BRIEF DESCRIPTION OF THE SEVERAL VIEWS OF THE DRAWING

FIG. 1 is a diagram showing a functional constitution example of a modular exponentiation calculation apparatus according to a first embodiment of the present invention;

FIG. 2 is a flowchart showing one example of a processing procedure of the calculation apparatus of FIG. 1;

FIG. 3 is a diagram showing an internal constitution example relating to each operation unit of the calculation apparatus of FIG. 1;

FIG. 4 is a part of the flowchart showing another example of the processing procedure of the calculation apparatus according to the embodiment in FIG. 2;

FIG. 5 is a diagram showing an internal constitution example relating to each operation unit of the modular exponentiation calculation apparatus according to another embodiment;

FIG. 6 is a diagram showing a functional constitution example of the modular exponentiation calculation apparatus according to still another embodiment;

FIG. 7 is a diagram showing an internal constitution example relating to each operation unit of the modular exponentiation calculation apparatus according to still further embodiment; and

FIG. 8 is an explanatory view of an enciphering system using the above embodiments.

### DETAILED DESCRIPTION OF THE INVENTION

An embodiment of a modular exponentiation calculation apparatus or method according to the present invention will now be described with reference to the accompanying drawings.

First Embodiment

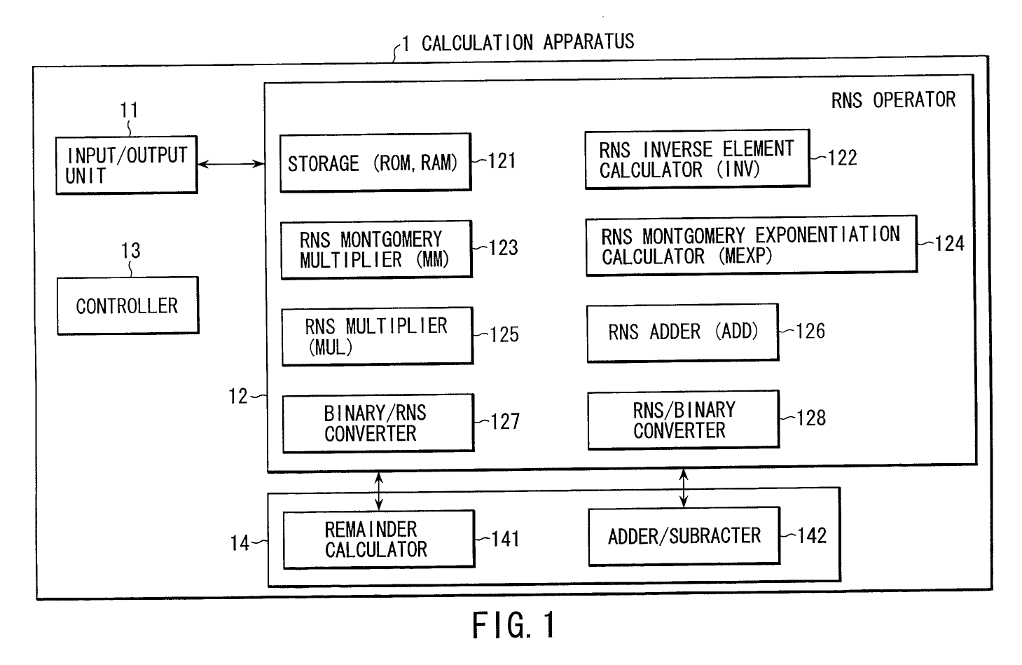

FIG. 1 shows a functional constitution diagram of a calculation apparatus according to one embodiment of the present invention.

A calculation apparatus 1 of the present embodiment comprises an RNS operator 12 for calculating an RNS represented integer; an operator 14 for performing an auxiliary operation in a binary representation; an input/output unit 11 for performing input/output with the external device; and a controller 13 for controlling the entire constitution.

The RNS operator 12 includes an RNS inverse element calculator 122; RNS Montgomery multiplier 123; RNS Montgomery exponentiation calculator 124; RNS multiplier 125; RNS adder 126; first representation converter (binary representation to RNS representation) 127; second representation converter (RNS representation to binary representation) 128; and storage 121.

The auxiliary operator 14 in the binary representation includes a remainder calculator 141; and adder/subtracter 142.

In the aforementioned operation units, the RNS operator 12 occupies a greater part in scale.

The storage 121 is constituted, for example, of ROM and RAM for storing bases utilized in the RNS representation, parameters calculated beforehand and stored in the apparatus, and the like.

The RNS Montgomery multiplier 123 performs the aforementioned RNS Montgomery multiplication of step-M-0 to step-M-8.

The RNS Montgomery exponentiation calculator 124 performs the aforementioned Montgomery exponentiation of step-E-1 to step-E-5.

The RNS multiplier 125 performs the aforementioned RNS multiplication.

The RNS adder 126 performs the aforementioned RNS addition.

The first representation converter 127 converts a binary representation to an RNS representation.

The second representation converter 128 converts the RNS representation to the binary representation.

Additionally, these are described in detail, for example, in Document 1 “Cox-Rower Architecture for Fast Parallel Montgomery Multiplication”, Kawamura, Koike, Sano, and Shimbo, EUROCRYPT 2000 LNCS 1807, pp. 523-538, 2000.

The RNS inverse element calculator 122 calculates <−x⁻¹>ₐ using <x>ₐ as an input. That is, −xᵢ⁻¹ is calculated from xᵢ with respect to each base aᵢ and element xᵢ of <x>ₐ (mod aᵢ). Concretely, the calculation is executed in the following procedure.

<Inverse Element Calculation in Base aᵢ>

step 0: Carmichael function λ(aᵢ) is calculated with respect to the base aᵢ, and stored in the storage 121. A concrete equation of Carmichael function λ is represented as follows. This calculation is described in “Contemporary Cryptography”, Sangyo Tosyo, p. 16, authored by Tatsuaki Okamoto, Hirotsuke Yamamoto. A bit size of λ(aᵢ) is not more than a bit size of aᵢ.

The following is [Fermat small theorem].

Assuming that a prime number is p, a^{p-1}≡1(mod p) is established with respect to an arbitrary integer a∈Zₚ other than 0.

Based on this theorem Euler function ψ(n) with respect to an integer n is the number of elements of Z*ₙ. For examples when p, q have different odd numbers of elements, ψ(p)=p−1, ψ(p^{e})=p^{e-1}(p−1), ψ(pq)=(p−1) (q−1).

Carmichael function λ(n) with respect to the integer n is defined as follows. When n=2^{eo}p^{e1}₁, . . . , p^{er}ᵣ (p₁, . . . , pᵣ have different odd numbers of elements)

$$\begin{matrix}λ ( n ) = LCM ( λ ( {2}^{eo} ) , ψ ( {p}_{1}^{e 1} ) , … , ψ ( {p}_{r}^{er} ) ) \\ λ ( {2}^{t} ) = {2}^{t - 1} if t < 3 \\ = {2}^{t - 2} if t ≧ 3\end{matrix}$$

With respect to all x(<aᵢ) prime to modulus aᵢ, x^{λ(ai)}=1 (mod aᵢ) is obtained. Here, the input x is assumed as secret keys p, q (prime numbers) or a product N (product of two prime numbers) of an RSA cryptography. Then, these are necessarily prime to the modulus aᵢ.

step 1: xᵢ⁻¹=xᵢ^{λ(ai)-1} is calculated by modular multiplication in the operation unit (mod aᵢ).

step 2:−xᵢ⁻¹=aᵢ−xᵢ⁻¹ is calculated.

In the above calculation, in the step 1, the bit size of the Carmichael function λ(aᵢ) is not more than the bit size of aᵢ. Therefore, when the number of words of the operation unit is set to 32 bits, the number of modular multiplication is 64 or less.

In the remainder calculator 141, a dividend x and divisor y of the binary representation are inputted, and x mod y is calculated. This calculation procedure can be executed by usual division, and described, for example, in “The art of computer programming”, Addison Wesley Longman, Inc., pp. 342-345 authored by Donald E. Knuth. The calculation amount is substantially the same as that of x1×x2.

The adder/subtracter 142 performs binary addition/subtraction.

The calculation apparatus 1 combines the following RNS operations and executes CRT exponentiation.

RNS Montgomery multiplication <z>=MM(<x>_{a∪b}, <y>_{a∪b}, p, a∪b)

Here, z=x×y×B⁻¹ mod p, or

z=(x×y×B⁻¹ mod p)+p.

RNS Montgomery exponentiation <z>=MEXP(<x>_{a∪b}, e, p, a∪b)

Here, z=x^{e}×B^{-(e-1)} mod p, or

z=(x^{e}×B^{-(e-1)} mod p)+p.

RNS multiplication <z>=MUL(<x>ₐ, <y>ₐ, a)

Here, z=x×y mod A (multiplication of x and y in the base “a”).

RNS addition <z>=ADD(<x>ₐ, <y>ₐ, a)

Here, z=x+y mod A (addition of x and y in the base “a”).

A last argument (a, a∪b, and the like) in the RNS operation denotes the base utilized in the RNS representation. Assuming that a value of the product of elements of the base “a” is A, and a value of the product of elements of the base “b” is B, a value of the product of elements of the base a∪b is A×B. Outputs of the RNS Montgomery multiplication and RNS Montgomery exponentiation are z<A and z<B.

As described above, in the RNS Montgomery multiplication and RNS Montgomery exponentiation, only a value of modulus p sometimes has a large result from a property of the Montgomery multiplication. That is, MM(<x>, <y>, p, a∪b)<2p and MEXP(<x>_{a∪b}, e, p, a∪b)<2p. When the modulus p is fixed, the output of the RNS Montgomery multiplication or the RNS Montgomery exponentiation is less than 2p, but this output can be inputted to the RNS Montgomery multiplication or the RNS Montgomery exponentiation as it is.

The following parameters are stored beforehand in the calculation apparatus 1.

Pre-registered parameters: base “a”, base “b”, product “A” of elements of the base “a”, product “B” of elements of the base “b”, product “A”×“B” of all elements of the bases “a” and “b”, “B²”, “<B⁻¹>ₐ”.

Additionally, as a relation of a parameter size in the bases “a”, “b” and CRT exponentiation, at least p<A, q<A, and p<B, q<B are necessary. As a result, with respect to N=p×q, at least N<A×B.

Here, the parameters inputted to the calculation apparatus 1 from the outside in order to execute the CRT exponentiation are as follows.

External input parameters: ciphertext C, dₚ=d mod (p−1), d_{q}=d mod (q−1), N (=p×q), p, q, inverse element pinv=p⁻¹ mod q in the modulus q of p, inverse element qinv=q⁻¹ mod p in the modulus p of q

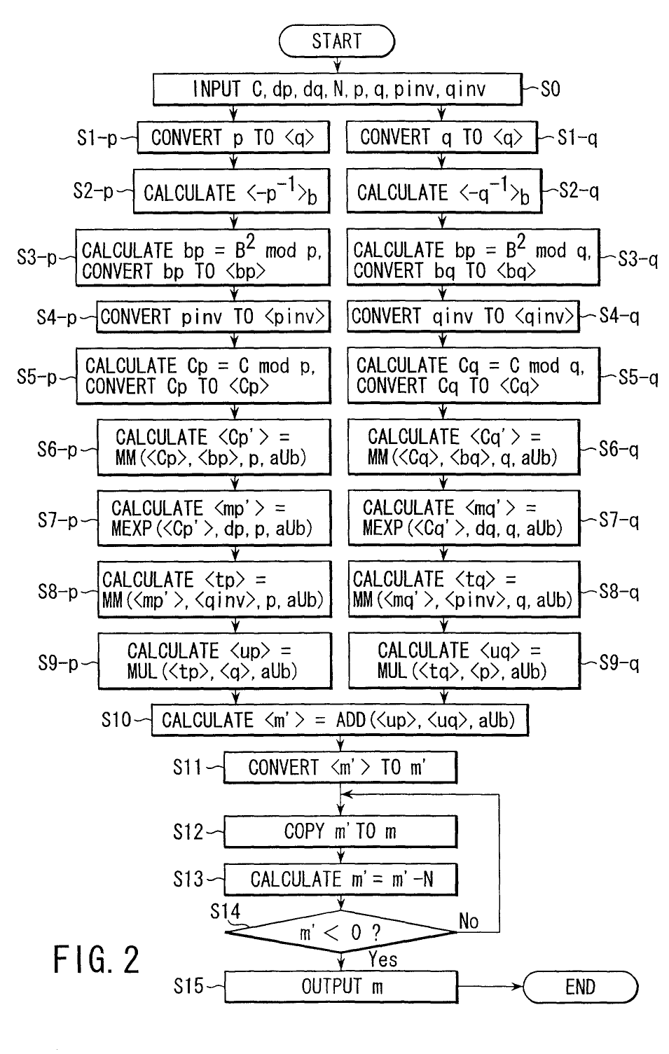

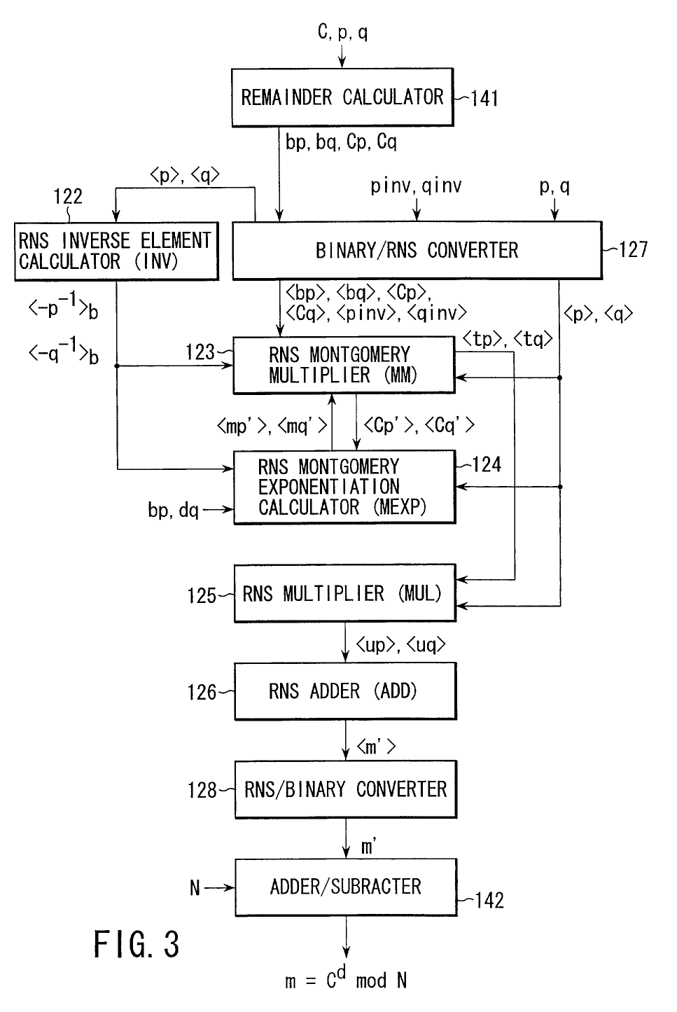

FIG. 2 shows one example of a processing procedure of the CRT exponentiation in the calculation apparatus 1. Moreover, FIG. 3 shows an internal constitution example relating to each operation unit of the calculation apparatus 1.

Step S0: The external input parameters C, dp, dq, N. p, q, pinv, qinv are inputted.

In the following procedure, in steps S1-p to S9-p, and S1-q to S9-q, and also in either corresponding step S1-p or S1-q, similar operation relating to two prime factors p and q of N is executed.

Step S1-p: The first representation converter 127 is utilized to convert the binary representation p to the RNS representation <p> by the base a∪b (=<p>ₐ ∪<p>_{b}={p mod a₁, p mod a₂, . . . , p mod aₙ} ∪ {p mod b₁, p mod b₂, . . . , p mod bₙ}).

Step S1-q: The first representation converter 127 is utilized to convert the binary representation q to the RNS representation <q> by the base a∪b (=<q>ₐ ∪<q>_{b}={q mod a₁, q mod a₂, . . . , q mod aₙ} ∪ {q mod b₁, q mod b₂, . . . , q mod bₙ}) by the base a∪b.

Step S2-p: The RNS inverse element calculator 122 is utilized to calculate <−p⁻¹>_{b} from <p>_{b} obtained by the step S1-p.

Step: S2-q: The RNS inverse element calculator 122 is utilized to calculate <−q⁻¹>_{b} from <q>_{b} obtained by the step S1-q.

Step S3-p: The remainder calculator 141 is utilized to calculate bp=B² mod p, and the first representation converter 127 is utilized to convert bp to the RNS representation <bp>by the base a∪b from the binary representation.

Step S3-q: The remainder calculator 141 is utilized to calculate bq=B² mod q, and the first representation converter 127 is utilized to convert bq to the RNS representation <bq> by the base a∪b from the binary representation.

Step S4-p: The first representation converter 127 is utilized to convert pinv to the RNS representation <pinv> by the base a∪b from the binary representation.

Step S4-q: The first representation converter 127 is utilized to convert qinv to the RNS representation <qinv> by the base a∪b from the binary representation.

Step S5-p: The remainder calculator 141 is utilized to calculate Cp=C mod p, and the first representation converter 127 is utilized to convert Cp to the RNS representation <Cp> by the base a∪b from the binary representation.

Step S5-q: The remainder calculator 141 is utilized to calculate Cq=C mod q, and the first representation converter 127 is utilized to convert Cq to the RNS representation <Cq> by the base a∪b from the binary representation.

Step S6-p: The RNS Montgomery multiplier 123 is utilized to calculate <Cp′>=MM(<Cp>, <bp>, p, a∪b).

<Processing Content with use of the Aforementioned Algorithm>

step-M-1: <s>ₐ=<Cp>ₐ×<bp>ₐ is calculated.

step-M-2: <s>_{b}=<Cp>_{b}×<bp>_{b} is calculated.

step-M-3: <t>_{b}=<s>_{b}×<−p⁻¹>_{b} is calculated.

step-M-4: <t>_{b} is base-converted to <t>ₐ.

step-N-5: <u>ₐ=<t>ₐ×<p>ₐ is calculated.

step-M-6: <v>ₐ=<s>ₐ+<u>ₐ is calculated.

step-M-7: <Cp′>ₐ=<v>ₐ×<B⁻¹>ₐ is calculated.

step-M-8: <Cp′>ₐ is base-converted to <Cp′>_{b}.

Thereby, RNS representation <Cp′> corresponding to either Cp′=C×B mod p or Cp′=(C×B mod p)+p is obtained.

Step S6-q: The RNS Montgomery multiplier 123 is utilized to calculate <Cq′>=MM(<Cq>, <bq>, q, a∪b). Additionally, when the aforementioned algorithm is utilized, the processing content is constituted by replacing p with q in the processing content of the step S6-p.

Thereby, RNS representation <Cq′> corresponding to either Cq′=C×B mod q or Cq′=(C×B mod q)+q is obtained.

Step S7-p: The RNS Montgomery exponentiation calculator 124 is utilized to calculate <mp′>=MEXP(<Cp′>, dp, p, a∪b).

<Processing Content with use of the Aforementioned Algorithm>

step-E-1: i=k is set. <y>_{a∪b}=<B>_{a∪b} is set.

step-E-2: <y>_{a∪b}=MM(<y>_{a∪b}, <y>_{a∪b}, p, a∪b) is calculated.

step-E-3: If dpᵢ=1, <y>_{a∪b}=MM(<y>_{a∪b}, <Cp′>_{a∪b}, p, a∪b) is calculated. If dpᵢ≠1, nothing is processed (nop).

Here, dpᵢ is a value of a lower i-th bit in binary representation (dpₖ, dpₖ₋₁, . . . , dp₁) of dp.

step-E-4: i=i−1 is set.

step-E-5: If i=0, the procedure ends. If i≠0, the procedure returns to the step-E-2.

Thereby, RNS representation <mp′> corresponding to mp′=Cp^{dp}×B mod p or mp′=(Cp^{dp}×B mod p)+p is obtained.

Step S7-q: The RNS Montgomery exponentiation calculator 124 is utilized to calculate <mq′>=MEXP(<Cq′>, dq, q, a∪b). Additionally, when the aforementioned algorithm is utilized, the processing content is constituted by replacing p with q in the processing content of the step S7-p.

Thereby, RNS representation <mq′>corresponding to either mq′=Cq^{dq}×B mod q or mq′=(Cq^{dq}×B mod q)+q is obtained.

Step S8-p: The RNS Montgomery multiplier 123 is utilized to calculate <tp>=MM(<mp′>, <q⁻¹ mod p>, p, a∪b).

<Processing Content with use of the Aforementioned Algorithm>

step-M-1: <s>ₐ=<mp′>ₐ×<qinv>ₐ is calculated.

step-M-2: <s>_{b}=<mp′>_{b}×<qinv>_{b} is calculated.

step-M-3: <t>_{b}=<s>_{b}×<−p⁻¹>_{b} is calculated.

step-M-4: <t>_{b} is base-converted to <t>ₐ.

step-M-5: <u>ₐ=<t>ₐ×<p>ₐ is calculated.

step-M-6: <v>ₐ=<s>ₐ+<u>ₐ is calculated.

step-M-7: <tp>ₐ=<v>ₐ×<B⁻¹>ₐ is calculated.

step-M-8: <tp>ₐ is base-converted to <tp>_{b}.

Thereby, the RNS representation <tp> corresponding to either tp=Cp^{dp}×q⁻¹ mod p or tp=(Cp^{dp}×q⁻¹ mod p)+p is obtained.

Step S8-q: The RNS Montgomery multiplier 123 is utilized to calculate <tq>=MM(<mq′>, <p⁻¹ mod q>, q, a∪b). Additionally, when the aforementioned algorithm is utilized, the processing content is constituted by replacing p with q in the processing content of the step S8-p.

Thereby, the RNS representation <tq> corresponding to either tq=Cq^{dq}×p⁻¹ mod q or tq=(Cq^{dq}×p⁻¹ mod q)+q is obtained.

Step S9-p: The RNS multiplier 125 is utilized to calculate <up>=MUL(<tp>, <q>, a∪b).

Thereby, the RNS representation <up> corresponding to up=tp×q mod (A×B) is obtained.

Step S9-q: The RNS multiplier 125 is utilized to calculate <uq>=MUL(<tq>, <p>, a∪b).

Thereby, the RNS representation <uq> corresponding to uq=tq×p mod (A×B) is obtained.

Step S10: The RNS adder 126 is utilized to calculate <m′>=ADD(<up>, <uq>, a∪b).

Thereby, the RNS representation <m′> corresponding to m′=up+uq mod (A×B) is obtained.

Step 11: The second representation converter 128 is utilized to convert <m′> to the binary representation m′ from the RNS representation (base a∪b).

Here, m′ is not less than N in some case. Therefore, when m′ is not less than N, the adder/subtracter 142 performs a processing for setting the value to be less than N.

Step S12: m′ is copied to m (stored).

Step S13: m′=m′−N is calculated.

Step S14: It is determined whether or not m′<0. Unless m′<0, the procedure returns to the step S12. If m′<0, the procedure comes out of a loop and shifts to step S15.

Step S15: m is outputted, and the procedure is ended.

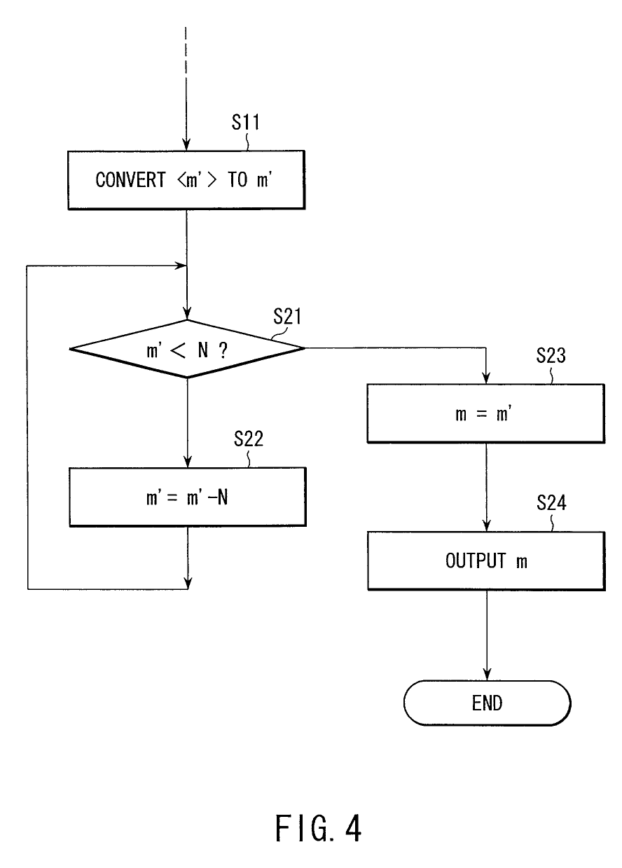

Additionally, instead of the steps S12 to S15, for example, other procedure such as steps S21 to S24 of FIG. 4 may be used.

Moreover, instead of inputting N from the outside, the adder/subtracter 142 may obtain N by p×q.

In the procedure, in the steps S5-p, S6-p and steps S5-q, S6-q, Cp′=C×B mod p (+p) and Cq′=C×B mod q (+q) are calculated, and the processing corresponds to the aforementioned processing of the step-C-2 in the usual CRT exponentiation.

The processing of the steps S7-p and S7-q corresponds to the processing of step-C-3 in the usual CRT exponentiation.

The processing of the steps S8-p, S9-p, S8-q, S9-q, S10 corresponds to the processing of step-C-4 in the aforementioned usual CRT exponentiation. Here, the processing of the step-C-4 can be modified as follows, and this respect is utilized.

$$\begin{matrix}m = mp \times ( {q}^{- 1} mod p ) \times q + mq \times ( {p}^{- 1} mod q ) \times p \\ \{ mp \times ( {q}^{- 1} mod p ) mod p \} \times q + \{ mq \times ( {p}^{- 1} mod q ) mod q \} \times p ( mod N )\end{matrix}$$

q) mod q}×p (mod N)

If there is no addition error of p and q in the RNS Montgomery multiplication, m′ as a result of the step S11 has a relation of m′<2N in the CRT modular exponentiation calculation. Therefore, if the addition error is considered, m′<4N results. Therefore, it is necessary to subtract 3N at maximum from m′, and a necessary correction is performed in the steps S12 to S14. Since m′ is converted to a binary number, it is easy to determine a positive/negative sign. This processing corresponds to the procedure for obtaining the remainder value in the modulus N in the processing of step-C-4 in the usual CRT exponentiation described in the product.

Each calculation step of the CRT modular exponentiation calculation can be executed using an operation function which can be executed by the RNS operator 12. Particularly the RNS Montgomery exponentiation of the steps S7-p and S7-q occupies a large part of the calculation processing, and it is important to utilize a sum group a∪b as a base in which bases a, b slightly larger than moduli p, q are used.

The calculation amount of the RNS Montgomery multiplication can be evaluated by the calculation amount of the base conversion executed in the multiplication. This processing requires the multiplication of the word size by an order of a base size n, when one base element is considered. Furthermore, this processing is executed for all base elements in the base to be converted. Therefore, the calculation amount of the RNS Montgomery multiplication is of the order of square of the base size n. Moreover, the calculation amount of the RNS Montgomery exponentiation corresponds to that of a processing for repeating the RNS Montgomery multiplication by a bit size L_e of the exponent. Therefore, the calculation amount of the RNS Montgomery exponentiation is O(n²×L_e).

Concretely, for example, an RSA cryptography of 1024 bits is assumed. In this case, each of secret key d, N and ciphertext C is of 1024 bits. Therefore, when this is executed in the Montgomery exponentiation in the RNS representation as in a conventional method, the base a′ (and b′) for use has the number of elements 33 (=1024/32 (word size)+1) at minimum. On the other hand, each of values Cp, Cq obtained by reducing secret keys dp, dq, p, q, C utilized in the CRT exponentiation as described in the embodiment by the moduli p, q is of 512 bits. Therefore, the base “a” (and “b”) to be utilized has the number of elements 17 (=512/32 (word size)+1) at minimum. It is most efficient for the processing time to utilize the minimum base element number. On this assumption, the calculation amount of the modular exponentiation calculation by the CRT is compared with that of the modular exponentiation calculation which does not use the CRT. The calculation amount of the RNS Montgomery multiplication of a case in which the CRT is used is ¼ of the calculation amount in a case in which the CRT is not used. The size of the exponent in the case in which the CRT is used is ½ of the calculation amount in the case in which the CRT is not used. When the CRT is used, it is necessary to calculate the RNS Montgomery exponentiation twice. Therefore, as a whole, according to the CRT modular exponentiation calculation, RSA deciphering operation can be realized with a processing amount of about ¼ as compared with the conventional RNS Montgomery exponentiation. Moreover, when the RNS Montgomery exponentiation is simultaneously executed in two circuits, the RSA deciphering operation can be realized at a processing amount of about ⅛ as compared with the conventional RNS Montgomery exponentiation.

As described above, according to the present embodiment, when the operation utilizing the Chinese remainder theorem, operation utilizing a residue number system, and Montgomery operation are united, the modular exponentiation calculation can be more efficiently executed.

Other embodiments will be described hereinafter.

In the procedure of FIG. 2, the procedure of the steps S1-p to S5-p may be performed in any order except that the step S2-p follows the step S1-p (the remainder calculator 141 and representation converter 127 are set to be processable in parallel, and a whole or a part of the processing may be performed in parallel).

Moreover, in the procedure of FIG. 2, in the steps S1-p and S1-q corresponding to the steps S1-p to S9-p and S1-q to S9-q, similar operations relating to two prime factors p and q of N are executed. For the operation of S1-p to S9-p, S1-q to S9-q, p and q parts may be executed by turns. Alternatively, after all the p parts are executed, all q parts may be executed. In the latter case, since storing/retrieving an intermediate variable to/from a memory decreases, an efficiency may be enhanced.

Furthermore, the p and q parts may also be processed in a pipeline manner.

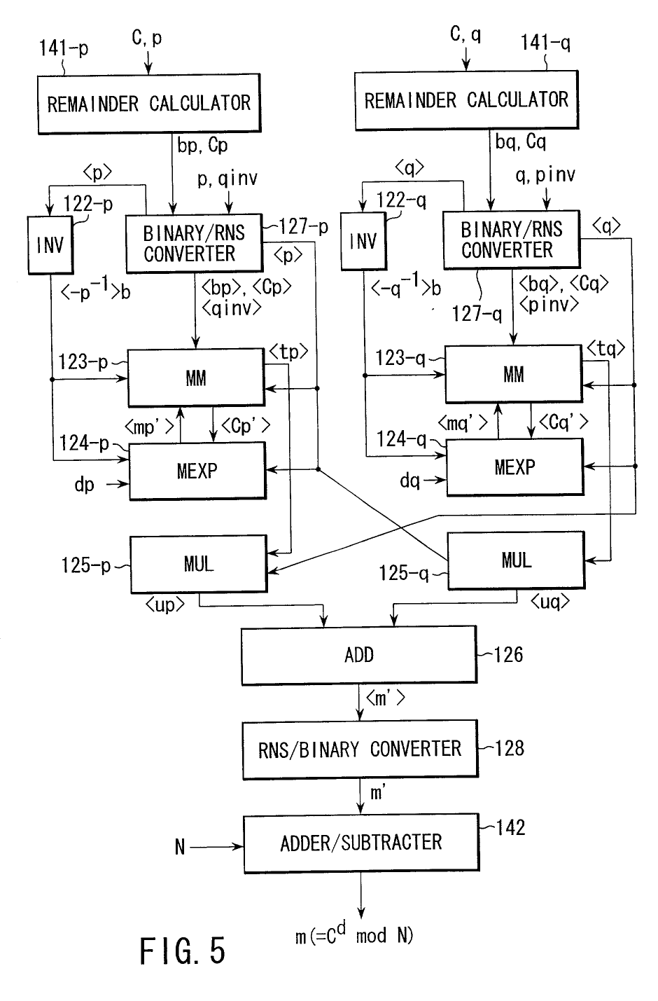

Additionally, when a whole or a part of the corresponding operation unit is set to be processable in parallel, the p and q parts can also be executed in parallel. The internal constitution example relating to each operation unit of the calculation apparatus 1 in a case in which the p and q parts are separately described is shown in FIG. 5.

Moreover, for example, all of the RNS Montgomery multiplier 123, RNS Montgomery exponentiation calculator 124, RNS multiplier 125, and RNS adder 126, only the RNS Montgomery multiplier 123 and RNS Montgomery exponentiation calculator 124, or only the RNS Montgomery exponentiation calculator 124 are set so that the processing of p parts and q parts can be performed in parallel.

Of course, each operation unit can perform a parallel calculation derived from the RNS operation and raise the speed. In this case, the operation with respect to all the elements of the base can be constituted to be executed simultaneously, and the operation with respect to some elements of the base (e.g., the number of elements corresponding to a factor of an integer indicating the base size) can be constituted to be executed at the same time.

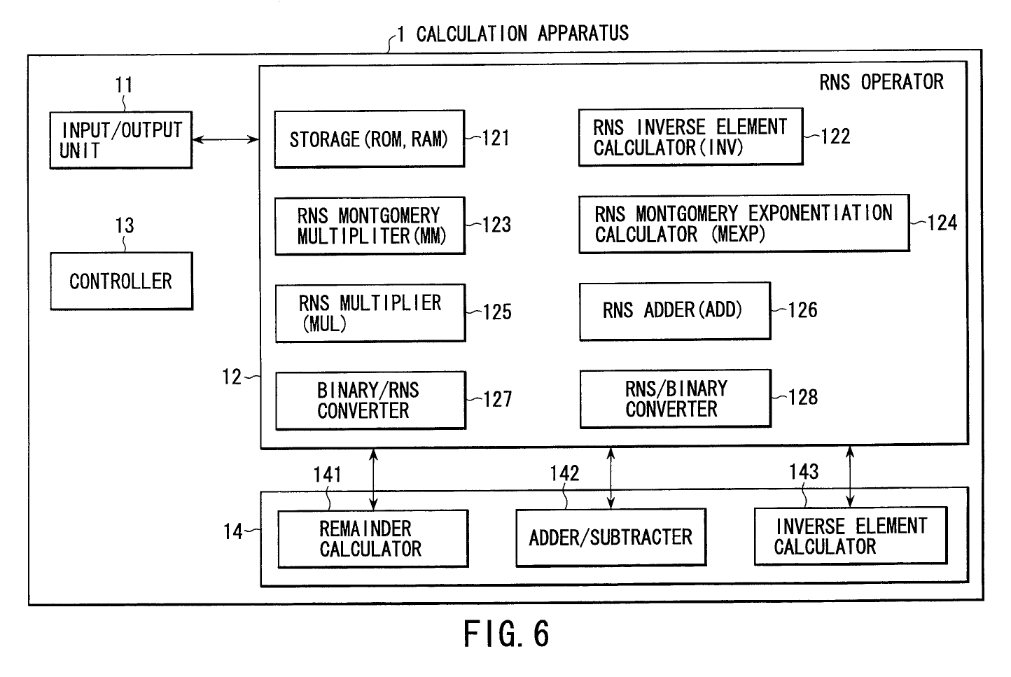

Moreover, in the aforementioned embodiment, an example in which pinv=p⁻¹ mod q, qinv=q⁻¹ mod p are inputted from the external device has been described, but these may be calculated from p, q. In this case, as shown in FIG. 6, as an auxiliary operation unit in the binary representation, in addition to the remainder calculator 141 and adder/subtracter 142, an inverse element calculator 143 may further be disposed.

In the inverse element calculator 131, integer x of the binary representation and value y of the modulus are inputted to calculate x⁻¹ mod y. This calculation is often executed by an algorithm called the extended Euclidean algorithm. The calculation is described, for example, in “The art of computer programming”, Addison Wesley Longman, Inc., pp. 342-345 authored by Donald E. Knuth. In general, the calculation amount corresponds to a calculation amount of about ten modular multiplication operations having a size of y.

Furthermore, the example in which dp=d mod (p−1), dq=d mod (q−1) are inputted from the outside has been described above in the constitution example, but may be calculated from p, q. The calculation can be performed by the remainder calculator 141.

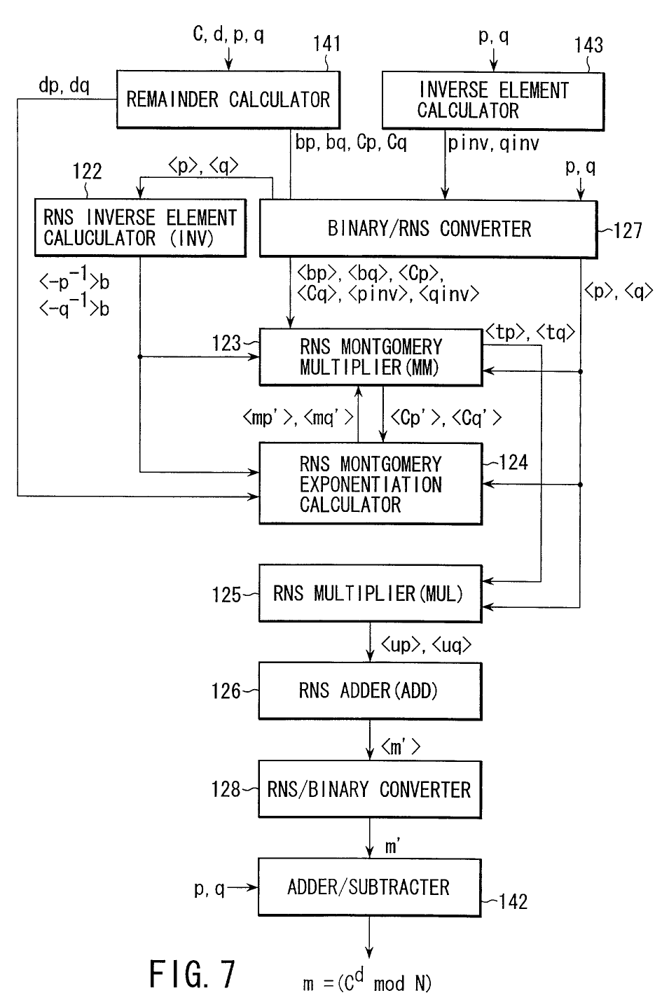

An internal constitution example relating to each operation unit of the calculation apparatus 1 in which pinv, qinv, dp, dq are calculated from p, q is shown in FIG. 7.

Additionally, for the external input parameters (ciphertext C, dp=d mod (p−1), dq=d mod (q−1), N(p=p×q), p, q, pinv=p⁻¹ mod q, qinv=q⁻¹ mod p), the parameters other than the ciphertext C are parameters corresponding to the secret key of RSA. It is also possible to store all or some of the parameters in the calculation apparatus 1. In this case, the ciphertext C and key identification information necessary for selecting a key parameter group in the calculation apparatus 1 may be inputted.

Moreover, the calculation shown in the steps S1-p to S4-p and steps S1-q to S4-q of FIG. 2 depends only on secret keys (p, q, pinv, qinv) of the RSA. However, the ciphertext C by the RSA differs with a session, but the RSA secret key is not changed very much (there can be a system in which the RSA secret key is unchanged).

Then, a result obtained by executing the steps S1-p to S4-q is stored. As long as the same RSA secret key is used, the steps S1-p to S4-q are skipped, and the result stored beforehand is utilized to perform the processing of and after the step S5-p. When the RSA secret key is changed, the steps S1-p to S4-q may be executed anew.

Furthermore, when the RSA secret key is managed by the key identification information, the result may be associated with the key identification information and stored.

Additionally, when the RSA secret key is single and unchanged, only C is inputted from the outside, and the data (p, q, N, <p>, <q>, <−p⁻¹>_{b}, <−q⁻¹>_{b}, <bp>, <bq>, <pinv>, <qinv>, <bp>, <bq>) depending only on the RSA secret key may be stored beforehand in the storage.

Moreover, when there are a plurality of RSA secret keys, only the C and key identification information are inputted from the outside. The data (p, q, N, <p>, <q>, <−p⁻¹>_{b}, <−q⁻¹>_{b}, <bp>, <bq>, <pinv>, <qinv>, <bp>, <bq>) depending only on the RSA secret key is associated with the key identification information, and stored beforehand in the storage. The data corresponding to the key identification information inputted from the outside may be read from the storage and used.

Furthermore, when two types of bases are used, with respect to the bases a={a₁, a₂, . . . , aₙ₁} and b={b₁, b₂, . . . , bₙ₂}, n1=n2 =n has been described, but it is also possible to set n1≠n2.

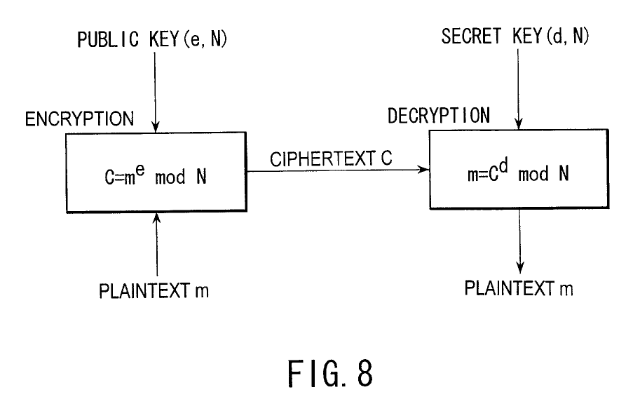

Additionally, the above-described embodiments can be applied to a communication system using an RSA cryptography, such as shown in FIG. 8. It is more effective to apply the present invention to a decryption (m=C^{d} mod N) which needs more calculation amount than an encryption. But, the encryption (C=m^{e} mod N) is represented by an equation similar to that of the decryption. Of course, the present invention can also be applied to the encryption (e.g., a case in which the apparatus having the secret key performs the encryption). In this case, in the above description, the plaintext m is inputted instead of the ciphertext C, and the exponent e may be used instead of the exponent d.

Hardware and software constitutions of the calculation apparatus will next be described.

The present embodiment has been described assuming that the present calculation apparatus (deciphering apparatus or enciphering apparatus) is realized by hardware, but it is also possible to realize the apparatus as software.

When the apparatus is constituted as hardware, the apparatus is formed, for example, as a semiconductor apparatus, and is mounted as an operation board or card in calculators such as a personal computer in one mode. When the calculator uses OS, a driver for the operation device may be incorporated in the OS and used in the other mode. Moreover, it is also possible to form the apparatus as the semiconductor apparatus, and to dispose the apparatus in apparatuses such as AV equipment and household electric appliances.

When the apparatus is realized by software, the apparatus can be implemented as program for allowing a computer to execute predetermined means (for allowing the computer to function as the predetermined means, or for allowing the computer to realize the predetermined function). Alternatively, the apparatus can also be implemented as a computer readable recording medium in which the program is recorded. Needless to say, it is also possible to utilize various fast techniques such as a multi-processor and pipeline processing.

According to the present invention, when the operation utilizing the Chinese remainder theorem, the operation utilizing the residue number system, and Montgomery operation are united, the modular exponentiation calculation can more efficiently be executed.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, other constitutions obtained by replacing a part of the illustrated constitution with another part, omitting a part of the illustrated constitution, adding another function or element to the illustrated constitution, or combining the constitutions are also possible. Moreover, another constitution logically equivalent to the illustrated constitution, another constitution including a part logically equivalent to the illustrated constitution, another constitution logically equivalent to a main part of the illustrated constitution, and the like are also possible. Furthermore, another constitution which achieves the same or similar object as the object of the illustrated constitution, another constitution which produces the same or similar effect as that of the illustrated constitution, and the like are also possible.

Additionally, it is possible to appropriately combine and implement various variations relating to various constituting parts described in the embodiment of the present invention.

Moreover, the mode for carrying out the present invention contains/includes various viewpoints, stages, concepts, and categories such as an invention as an individual apparatus, invention relating to two or more associated apparatuses, invention as a whole system, invention relating to constituting parts inside the individual apparatus, and invention of a corresponding method.

Therefore, the present invention can be extracted from a content disclosed in the content described in the embodiment of the present invention without limiting the present invention to the illustrated constitution.

The present invention is not limited to the aforementioned modes, and can variously be modified and implemented in the technical scope.

Moreover, the present invention can also be implemented as a computer readable recording medium in which a program for allowing a computer to execute predetermined means, allowing the computer to function as predetermined means, or allowing the computer to realize a predetermined function is recorded.

What is claimed is:

1. A modular exponentiation calculation apparatus which utilizes a residue number system representation by a first base and a second base including sets of a plurality of integers with respect to object data C and parameters p, q, d (all integers included in both the bases are mutually primary, a product “A” of all the integers of the first base is A>p, A>q, a product “B” of all the integers of the second base is B>p, B>q, and A×B>C) to obtain a calculation result m=C^{d} mod (p×q), said apparatus comprising:
a first processing unit configured to obtain a residue number system representation of a value Cp^{dp}×B mod p or a value with p added thereto based on a residue number system representation of a remainder value Cp=C mod p by p of said data C and a remainder value dp=d mod (p−1) by (p−1) of said parameter d;
a second processing unit configured to obtain a residue number system representation of a value Cq^{dq}×B mod q or a value with q added thereto based on a residue number system representation of a remainder value Cq=C mod q by q of said data C and a remainder value dq=d mod (p−1) by (q−1) of said parameter d;
a third processing unit configured to obtain a residue number system representation of an integer m′ congruent with C^{d} mod (p×q) based on both the residue number system representations obtained by said first and second processing units; and
a fourth processing unit configured to obtain said calculation result m based on a value of said integer m′ obtained by converting said residue number system representation obtained by said third processing unit into a binary representation.

2. The modular exponentiation calculation apparatus according to claim 1, wherein said first processing unit performs a residue number system Montgomery multiplication of the residue number system representation of said remainder value Cp and the residue number system representation of B² mod p, performs a residue number system Montgomery exponentiation using said remainder value dp as an exponent portion with respect to the obtained residue number system representation, and thereby obtains the residue number system representation of the value Cp^{dp}×B mod p or the value with p added thereto, and
said second processing unit performs a residue number system Montgomery multiplication of the residue number system representation of said remainder value Cq and the residue number system representation of B² mod q, performs a residue number system Montgomery exponentiation using said remainder value dq as the exponent portion with respect to the obtained residue number system representation, and thereby obtains the residue number system representation of the value Cq^{dq}×B mod q or the value with q added thereto

3. The modular exponentiation calculation apparatus according to claim 2, further comprising a unit configured to obtain said remainder value dp and said remainder value dq based on said parameters p, q, and d.

4. The modular exponentiation calculation apparatus according to claim 1, wherein said third processing unit performs a residue number system Montgomery multiplication of said residue number system representation obtained by said first processing unit and the residue number system representation of an inverse element qinv=q⁻¹ mod p in a modulus p of said parameter q, performs a residue number system multiplication of the obtained residue number system representation and the residue number system representation of said parameter q, performs a residue number system Montgomery multiplication of said residue number system representation obtained by said second processing unit and the residue number system representation of an inverse element pinv=p⁻¹ mod q in a modulus q of said parameter p, performs a residue number system multiplication of the obtained residue number system representation and the residue number system representation of said parameter p, performs a residue number system addition of both obtained results of a residue number system multiplication, and obtains the residue number system representation of the integer m′ as the combination with C^{d} in said modulus p×q.

5. The modular exponentiation calculation apparatus according to claim 4, further comprising a unit configured to convert the binary representations of said parameter p, said parameter q, said inverse element pinv, and said inverse element qinv to the residue number system representations.

6. The modular exponentiation calculation apparatus according to claim 5, further comprising a unit configured to obtain the inverse element pinv and the inverse element qinv in the modulus p of said parameter q based on said parameters p and q.

7. The modular exponentiation calculation apparatus according to claim 1, further comprising a unit configured to obtain said remainder value Cp and said remainder value Cq based on said data C and said parameters p and q.

8. The modular exponentiation calculation apparatus according to claim 1, further comprising a storage unit configured to store data of a residue number system representation depending only on said parameters p, q, d.

9. The modular exponentiation calculation apparatus according to claim 1, further comprising a storage unit configured to store identification information i for identifying said parameters, and data of a residue number system representation depending only on parameters pi, qi, di corresponding to the identification information i.

10. The modular exponentiation calculation apparatus according to claim 1, wherein said first processing unit and said second processing unit execute at least a part of a processing at the same time.

11. The modular exponentiation calculation apparatus according to claim 1, wherein said first processing unit and said second processing unit simultaneously execute all or some of operations corresponding to elements with respect to operations to be performed for respective elements of said base.

12. The modular exponentiation calculation apparatus according to claim 1, wherein said fourth processing unit includes:
a subunit configured to convert the residue number system representation of said integer m′ obtained by said third processing unit to a binary representation; and
a unit configured to set a value of said integer m′ less than p×q obtained by the subunit or a value less than p×q obtained by subtracting a predetermined number p×q from said integer m′ not less than p×q to m=C^{d} mod p×q.

13. The modular exponentiation calculation apparatus according to claim 1, wherein the number of elements of said first base is the same as the number of elements of said second base.

14. A modular exponentiation calculation method which utilizes a residue number system representation by a first base and a second base including sets of a plurality of integers with respect to object data C and parameters p, q, d (all integers included in both the bases are mutually primary, a product “A” of all the integers of the first base is A>p, A>q, a product “B” of all the integers of the second base is B>p, B>q, and A×B>C) to obtain a calculation result m=C^{d} mod (p×q), said method comprising:
obtaining a first residue number system representation of a value Cp^{dp}×B mod p or a value with p added thereto based on a residue number system representation of a remainder value Cp=C mod p by p of said data C and a remainder value dp=d mod (p−1) by (p−1) of said parameter d;
obtaining a second residue number system representation of a value Cq^{dq}×B mod q or a value with q added thereto based on a residue number system representation of a remainder value Cq=C mod q by q of said data C and a remainder value dq=d mod (p−1) by (q−1) of said parameter d;
obtaining a third residue number system representation of an integer m′ congruent with C^{d} mod (p×q) based on the first and second residue number system representations; and
obtaining said calculation result m based on a value of said integer m′ obtained by converting said third residue number system representation into a binary representation.

15. An article of manufacture comprising a computer usable medium having computer readable program code means embodied therein, the computer readable program code means utilizing a residue number system representation by a first base and a second base including sets of a plurality of integers with respect to object data C and parameters p, q, d (all integers included in both the bases are mutually primary, a product “A” of all the integers of the first base is A>p, A>q, a product “B” of all the integers of the second base is B>p, B>q, and A×B>C) to obtain a calculation result m=C^{d} mod (p×q), the computer readable program code means comprising:
computer readable program code means for causing a computer to obtain a first residue number system representation of a value Cp^{dp}×B mod p or a value with p added thereto based on a residue number system representation of a remainder value Cp=C mod p by p of said data C and a remainder value dp d mod (p−1) by (p−1) of said parameter d;
computer readable program code means for causing a computer to obtain a second residue number system representation of a value Cq^{dq}×B mod q or a value with q added thereto based on a residue number system representation of a remainder value Cq=C mod q by q of said data C and a remainder value dq=d mod (p−1) by (q−1) of said parameter d;
computer readable program code means for causing a computer to obtain a third residue number system representation of an integer m′ congruent with C^{d} mod (p×q) based on the first and second residue number system representations; and
computer readable program code means for causing a computer to obtain said calculation result m based on a value of said integer m′ obtained by converting said third residue number system representation into a binary representation.

16. A decryption apparatus which utilizes a residue number system representation by a first base and a second base including sets of a plurality of integers with respect to ciphertext data C and secret keys d and N=p×q (all integers included in both the bases are mutually primary, a product “A” of all the integers of the first base is A>p, A>q, a product “B” of all the integers of the second base is B>p, B>q, and A×B>C) to obtain a plaintext m=C^{d} mod (p×q), said apparatus comprising:
a first processing unit configured to obtain a residue number system representation of a value Cp^{dp}×B mod p or a value with p added thereto based on a residue number system representation of a remainder value Cp=C mod p by p of said data C and a remainder value dp=d mod (p−1) by (p−1) of said key d;
a second processing unit configured to obtain a residue number system representation of a value Cq^{dq}×B mod q or a value with q added thereto based on a residue number system representation of a remainder value Cq=C mod q by q of said data C and a remainder value dq=d mod (p−1) by (q−1) of said key d;
a third processing unit configured to obtain a residue number system representation of an integer m′ congruent with C^{d} mod (p×q) based on both the residue number system representations obtained by said first and second processing units; and
a fourth processing unit configured to obtain said plaintext m based on a value of said integer m′ obtained by converting said residue number system representation obtained by said third processing unit into a binary representation.
